(19) United States
(12) Patent Application Publication
(10) Pub. No.: US 2007/0086483 A1
(43) Pub. Date: Apr. 19, 2007

(54) Method and system for policing binary flows in a switching device

(75) Inventor: Martin G. Greenberg, Mars, PA (US)

Correspondence Address: BROWDY AND NEIMARK, P.L.L.C.;624 NINTH STREET, NW, SUITE 300, WASHINGTON, DC, 20001-5303, US

(73) Assignee: Eci Telecom DND, Inc., Pittsburgh, PA (US)

(21) Appl. No.: 11/540,632

(22) Filed: Oct. 2, 2006

(30) Foreign Application Priority Data
Oct. 2, 2005 (IL) 171259

(51) Int. Cl. H04J 3/22

(52) U.S. Cl. 370/468

(57) ABSTRACT

A technique for policing an N-th granularity level binary flow in a network switching device also handling an (N+1)-th granularity level binary flow which is supposed to incorporate the N-th granularity level binary flow, the technique comprises dynamic bandwidth allocation for the N-th granularity level binary flow, based on dynamically obtaining F and processing information of queuing parameters associated with the (N+1)-th granularity level binary flow.

### FIELD OF THE INVENTION

The invention relates to a technology of policing binary (or data) flows in a networking device such as a router, a cross-connect, a switching fabric, preferably characterized by the limited output bandwidth capability and/or by having shared resources for outgoing flows.

### BACKGROUND OF THE INVENTION

A problem of bandwidth allocation to contending connections in telecommunication networks is being discussed in the related art, for example in U.S. Pat. No. 6,385,168 that discloses one algorithm utilizing parameters of queues, such as a queue depth.

Various solutions for policing data traffic are known in the art, for example U.S. Pat. No. 6,618,356 and 6,901,052.

The kind of a networking device which will be discussed in the present patent application, handles a plurality of binary flows, and is forced to perform policing of the flows for any reason including, but not limited to, ensuring judicious bandwidth allocation, resolution of conflicts for shared resources, or enforcement of contracted service limits.

Usually, such networking devices identify a flow based upon static parameters such as priority, protocol, and addresses. The flow is then subject to a policing stage per flow which is followed by queuing, discarding, and/or scheduling stage(s). After the per flow processing, the data progresses to a higher granularity stage which may be either more discarding/queuing/scheduling stages or an output stage.

Presently, the policing stage, per flow, at the finest level of granularity is blind i.e., is based on examining static parameters assigned to the flow only. The policing setting is generally, from the perspective of the networking hardware, a fixed value based on what the customer has purchased or that some software protocol sets based on system parameters. The policing stage presently does not include examining whether bandwidth would be available to the finest granularity flow upon its queuing and scheduling. In a simple exemplary case, bandwidth allocation across the plurality of fine granularity flows is presently performed at the first level of scheduling, i.e. after all the fine granularity flows pass the fine granularity queues (first level queues) and arrive at the first level scheduler.

FIG. 1 (prior art) illustrates a simple diagram of handling a fine granularity flow in presently known routers, switches and the like. FIG. 1 shows, inter alia, a chain 10 which begins with a formal policy block (policer 12) of a fine granularity flow FGF1, the policer is followed by one or more discarding blocks (generally marked 14), and further with a queue (first level queue) block 16. The cells (frames, packets) of the fine granularity flow FGF1, which were accepted by the policer 12 and have not been discarded by the discarding blocks 14, pass to the first level queue 16 (queue of this fine granularity flow), and then the data is handled by a scheduling block (a 1^{st} level scheduling block) 18. The policing block 12 can be common for a plurality of fine grained flows (FGF2, . . . FGFn), and the flows, upon passing through the policer, are distributed to their individual discarding blocks and queues.

The discarding blocks of a particular fine grained flow make discard decisions based upon the state of the queue for the flow (schematically shown by arrow 20), the availability of shared resource 30 (arrow 22), and/or congestion avoidance algorithms (arrow 24). The scheduling block 18 chooses between all the fine granularity queues (16, 26, . . . 36 of the flows FGF1, FGF2, . . . FGFn) and transfers the data to the next stage: either to another queue 28 (“second level” queue), or to an output (not shown).

FIG. 1 illustrates one possible example of a shared resource 30 being a memory, where queues of the first level are physically implemented in an external memory 30.

In FIG. 1, selection of the fine grained queues at the 1st level scheduler 18 is based upon its bandwidth (or rates) allocation algorithm, the congestion state “downstream” (either at a “2nd level queue 28, or an output), and the configuration of the router (switch). The scheduler block's 15l8 operation, in combination with the algorithms used by the discard block(s), indirectly causes additional policing/discarding in cases where the aggregate of the plurality of the fine grained flows temporarily or chronically exceeds the capacity of the downstream resource(s).

In a basic case, the 1^{st} level schedulers 18 are relatively simplistic and send data from the 1^{st} level queues in a fixed pattern ignorant of rate. The second level scheduler 32 is responsible for allocating rate among the second level queues. A shared resource 40, which actually reflects the bandwidth available, is shown in FIG. 1 as being connected to the 2^{nd} level scheduler 32.

Prior system designs provided extensive policing, queuing, and scheduling resources to allow for implementation of high Quality of Service at a fine granularity; usually per flow or logical interface. The cost of providing these resources has become prohibitive in the face of current cost pressure, and there is a question whether similar results can be achieved in a simpler, more cost effective manner.

### OBJECT OF THE INVENTION

It is therefore the object of the present invention to improve the policing function per data flow in order to save the costly queuing and scheduling in the switching device.

### SUMMARY OF THE INVENTION

The above object can be achieved by making the policing function of a fine granularity flow policing block smarter, namely by providing the policing function with a capability to take part in resolving the task of utilizing shared resources, such as the task of bandwidth allocation.

The Inventor has found that the policing function at a fine granularity flow (1^{st} level flow, lower hierarchy flow) can be improved by dynamically taking into account, at the policing block of the 1^{st} level flow, parameters of a higher level granularity queue (“2^{nd} level” queue, higher hierarchy queue) associated with the higher granularity/higher hierarchy flow (2^{nd} level flow).

The main two groups of parameters of the second level queue, which are to be taken into account, are the group of its static parameters and a group of its dynamic parameters.

The group of static parameters of the 2^{nd} level queue comprises customer/user settings for the 2nd level queue, such as (maximum) size of the 2^{nd} level queue, and the maximal bandwidth allocated to the 2nd level flow, as determined by the network engineer or customer's contract.

The group of dynamic parameters comprises the depth (congestion state) of the 2^{nd} level queue and, potentially, any dynamic feedback from a 3^{rd} (or higher) level of hierarchy, concerning its parameters and/or its dynamic state.

It has been found that if the fine grained flow policing block is informed (by any means including software/hardware control) at least about static parameters and the congestion state of the higher order flow, there is no need in providing (or activating) a hardware queuing block and a scheduler for this fine grained flow, since the policer of this fine grained flow can be entitled to make the bandwidth allocation decisions (and the corresponding discard decisions) concerning the fine grained flow just based on the information on the higher granularity flow that anyway incorporates the mentioned fine granularity flow.

In practice, the fine grained flow policer is proposed to have a function which, based on the information obtained about the 2^{nd} level queue (and optionally, some other information) could provide fair or approximate bandwidth allocation for the fine grained flow, which may then be enforced by the finest granularity flow (1^{st} level) policer.

Generally speaking, the invention provides a method of policing an N-th granularity level binary flow in a network switching device, wherein the switching device also handles an (N+1)-th granularity level binary flow supposed to incorporate said N-th granularity level binary flow, wherein said policing comprises dynamic bandwidth allocation for said N-th granularity level binary flow, based on dynamically obtaining and processing information of queuing parameters associated with said (N+1)-th granularity level binary flow.

One should appreciate that the dynamic bandwidth allocation for said N-th granularity level binary flow may additionally take into account dynamic feedback from still a higher, (N+2)-th level of hierarchy (data about queuing parameters of an (N+2)th granularity level binary flow incorporating said (N+1)-th granularity level binary flow).

In one simple version of the method, the N-th granularity level binary flow is a finest or 1^{st} granularity binary flow, and the (N+1)-th granularity level binary flow is a 2^{nd} granularity binary flow which is supposed to incorporate the 1^{st} granularity binary flow. The queuing parameters of the 2^{nd} granularity binary flow comprise a number of static and dynamic parameters of a 2^{nd} level queue, as discussed above.

Parameters at different levels of hierarchy are the same (queue size, minimum rate, maximum rate, etc.), just the names may change—instead of being a rate for a flow at the 1^{st} level, it is a rate for a “virtual channel” (an aggregate of flows) at the 2^{nd} level, a “virtual channel group” (an aggregate of virtual channels at the 3^{rd} level, etc.

In a simple case, the policed rate (bandwidth) of a 1^{st} level flow can be reduced in proportion to the space remaining in the 2^{nd} level queue. The dynamic policer could compute the fullness level of the queue as a fractional value between 0 and 1 using the formula:
Fullness level=(1−(Depth of 2^{nd} level queue Maximum size of 2^{nd} level queue))
and then reduce the policing rate for the fine grained flow by multiplying the static policing rate for the 1^{st} level flow by the computed fullness level.

More generally, the dynamical bandwidth allocation can be performed by multiplying the configured (sustained) rate of said at least one N-th granularity level binary flow by a rate factor depending at least on current depth of a queue for queuing the (N+1)-the granularity level binary flow.

In the above-described example, the rate factor is just equal to the value (level) of fullness F computed close to the following formula:
F=(1−D/Dmax), wherein:
D—current Depth of the queue for queuing the (N+1)-th granularity level binary flow;
Dmax—maximum Depth of said queue.

Other reasonable possibilities could be proposed, for example:
a) to specify a more complex function relating depth of the 2^{nd} level queue to reduction in the policed rate;
b) to perform a “min” or “max” function where the depth of the second level queue and some other variable, such as percentage remaining of a shared resource, could both cause a reduction based on which was more critical;
c) to introduce a random factor to preemptively prevent critical congestion similar to the known WRED algorithm, where WRED is an algorithm of Weighted Random Early Discard, by which packets are probabilistically dropped where the probability increases as congestion increases. The goal of WRED is preventing congestion from reaching a point where a catastrophic failure occurs;
d) to use a dynamic state from even further level into the hierarchy to reduce response time to congestion at, say, the output port.

One additional detailed example of the improved policing function and bandwidth allocation algorithm, where the dynamical bandwidth allocation is performed on a per-flow basis, by governing a peak rate of a fine granularity flow to be a function of depth of a higher level queue.

According to a second aspect of the invention, and in general terms, there is provided a system for policing one or more N-th granularity level binary flows in a network switching device, wherein the switching device also handles an (N+1)-th granularity level binary flow incorporating at least one of said N-th granularity level binary flows, the system comprises
an N-th granularity level policer for policing said one or more N-th granularity level binary flows;
an (N+1)-th granularity level queue for queuing said (N+1)-th granularity level binary flow,
means for dynamically obtaining feedback information of queuing parameters associated with said (N+1)-th granularity level binary flow in the (N+1)-th granularity level queue and providing said feedback information to said N-th granularity level policer,
   wherein said N-th granularity level policer being adapted to perform dynamic bandwidth allocation for said one or more N-th granularity level binary flows, based on said feedback information.

The means for dynamically obtaining feedback information from the N+1 level queue may be similar to those for N level queues. The N-th policer may compute rates by utilizing various functions. Some examples of such functions are presented in the text and schematically modeled in FIGS. 3 to 5.

In case the switch additionally handles an (N+2)-th granularity level binary flow incorporating said (N+1)-th granularity level binary flow, the system may further comprise

an (N+2)-th granularity level queue for queuing said (N+2)-th granularity level binary flow, and

an additional means, for dynamically obtaining additional feedback information about queuing parameters of said (N+2)-th granularity level binary flow in the (N+2)-th granularity level queue and providing it to the N-th granularity level policer,

wherein said N-th granularity level policer is capable of performing dynamic bandwidth allocation for said one or more N-th granularity level binary flows, based on said additional feedback information.

### BRIEF DESCRIPTION OF THE DRAWINGS

The invention will further be described and illustrated with the aid of the following non-limiting drawings, in which:

FIG. 1 (prior art) schematically illustrates one presently used system for policing fine granularity binary flows in a networking device

FIG. 2 schematically illustrates the proposed method and the system for more effective policing the fine granularity flows.

FIG. 3 is a block diagram of a model for a policer allowing regulation of rate.

FIG. 4 is a schematic diagram of a number of lower granularity flows to be integrated into a higher granularity flow, for an example of bandwidth allocation.

FIG. 5 is a graphical representation of a function for bandwidth allocation built for the example shown in FIG. 4, the function can be utilized for improving an N-th (say, the 1^{st}, the lowest) granularity level policer.

### DETAILED DESCRIPTION OF ONE PREFERRED EMBODIMENT

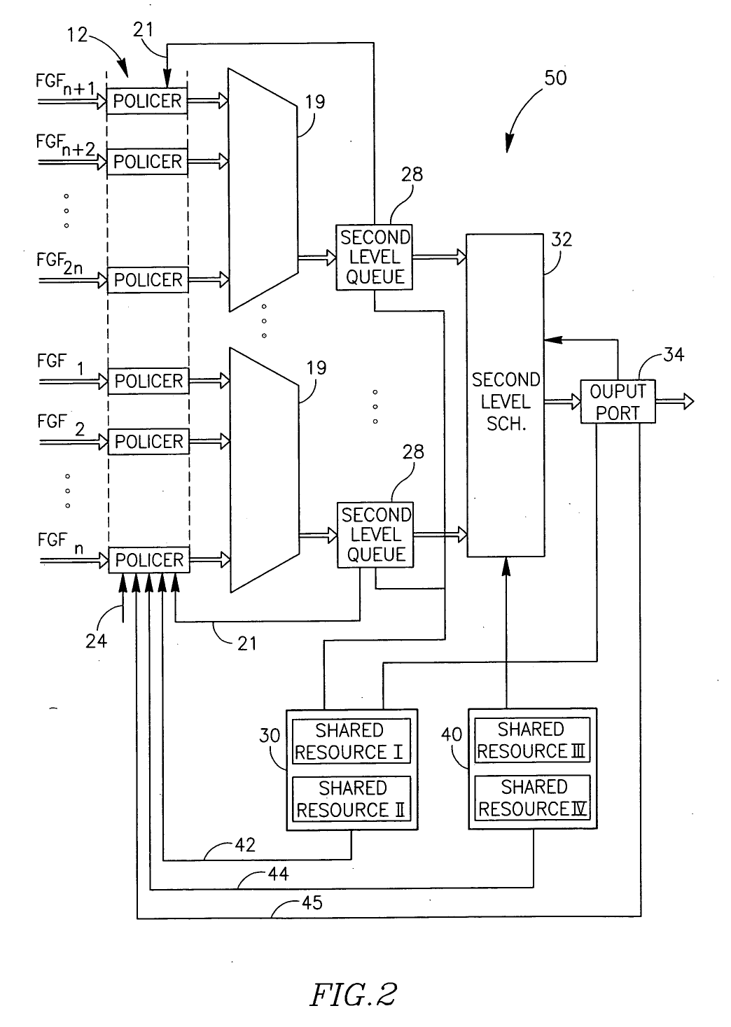

FIG. 2 illustrates one embodiment of the proposed system 50 for handling a fine granularity data stream in a networking device such as a router.

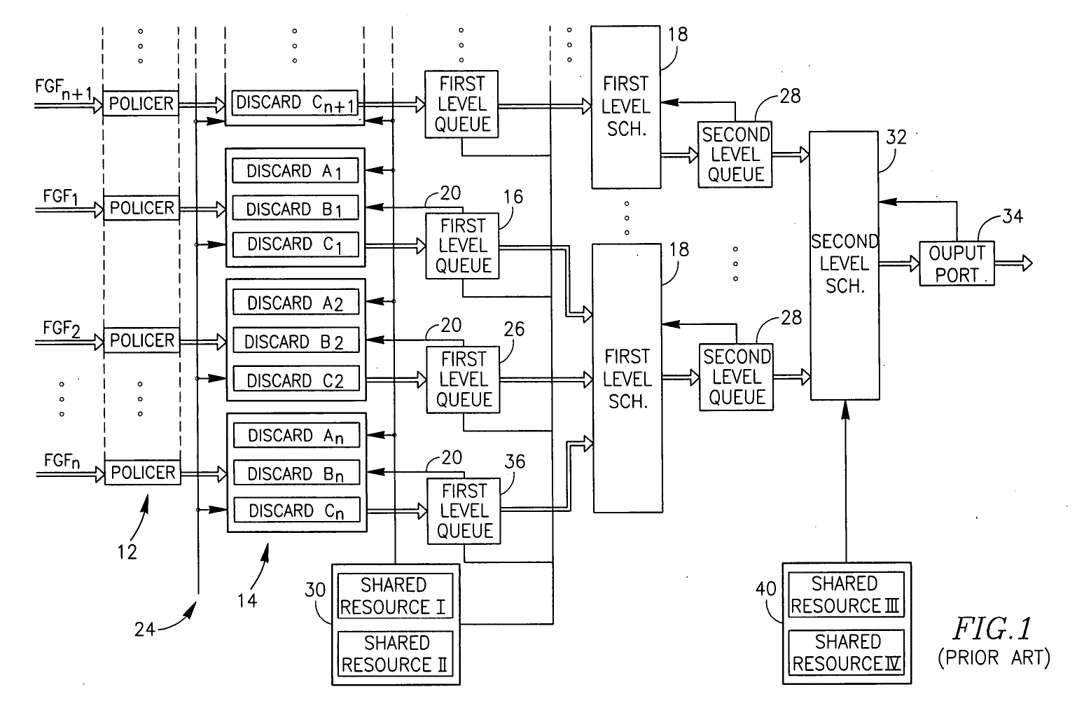

The diagram of FIG. 2 differs from that of FIG. 1 by the fact that instead of passing the congestion state and other information concerning the 1^{st}, level queues that originally went to the 1st level discard blocks and first level scheduler (14, 18 in FIG. 1), so-called feedback information (arrows 21) is now passed straight to the 1^{st} level policing block (12, FIG. 2) from the 2nd level queuing block (28, FIG. 2). The 1^{st} level discard blocks are considered part of the policer 12. In the example of FIG. 2, the 1st level queues (16, 26, 36, FIG. 1), and the 1st level scheduler (18, FIG. 1) are eliminated. The system 50 may still comprise queuing hardware, but the total number of levels of the queues will be reduced.

The 1st level policer 12 is now capable of performing bandwidth allocation already at the 1^{st} level, based on the feedback information 21 and some other system state information/settings that can also be passed to the policer 12. For example, it can be an additional feedback information 45 from a third level queue which, in this drawing, can be comprised in the output port 34.

The fine granularity flows, for example FGF1, FGF2, . . . FGFn, upon being partially discarded by the policer 12, are fed via a block 19, as a higher granularity flow, to the 2^{nd} level queuing block 28. Block 19 may serve as a concentrator. In a case (not shown) when the fine granularity flows are preliminarily arranged in a single stream, the policer 12 acts on each one when it arrives.

The 2^{nd} level scheduling block 32 performs final allocation of bandwidth and distribution of the 2^{nd} level binary flow to an output port (say, 34) and shared resources 40, based on state information which can be obtained from the shared resources 30 and 40, the output port as well as the system settings.

The mentioned state information/settings passed to the policer 12, are for example the congestion avoidance algorithms (24) and information concerning the shared resources (42, 44).

In contrast with the system shown in FIG. 1, information on status of the shared resources 30 and 40 is supplied to the 1^{st} level policer 12 (arrows 42, 44). The shared resource 30 is a single external memory where all queues, regardless of level are physically implemented. In this example, the shared resource 30 implements all the 2^{nd} level queues 28, all the remaining 1^{st} level queues (if any, not shown), and the queuing facilities of the output port 34 which can be considered the 3^{rd} level queue.

The second level scheduler 32 is responsible for allocating rate (bandwidth) among the 2^{nd} level queues 28. The shared resource 40 (the available bandwidth) serves an additional input to the 1^{st} level policer 12, both directly (44) and indirectly, via the 2^{nd} level queues 28.

FIG. 2 therefore illustrates that dynamic parameters of the 2^{nd} level policer 12 further comprise dynamic status of at least one shared resource.

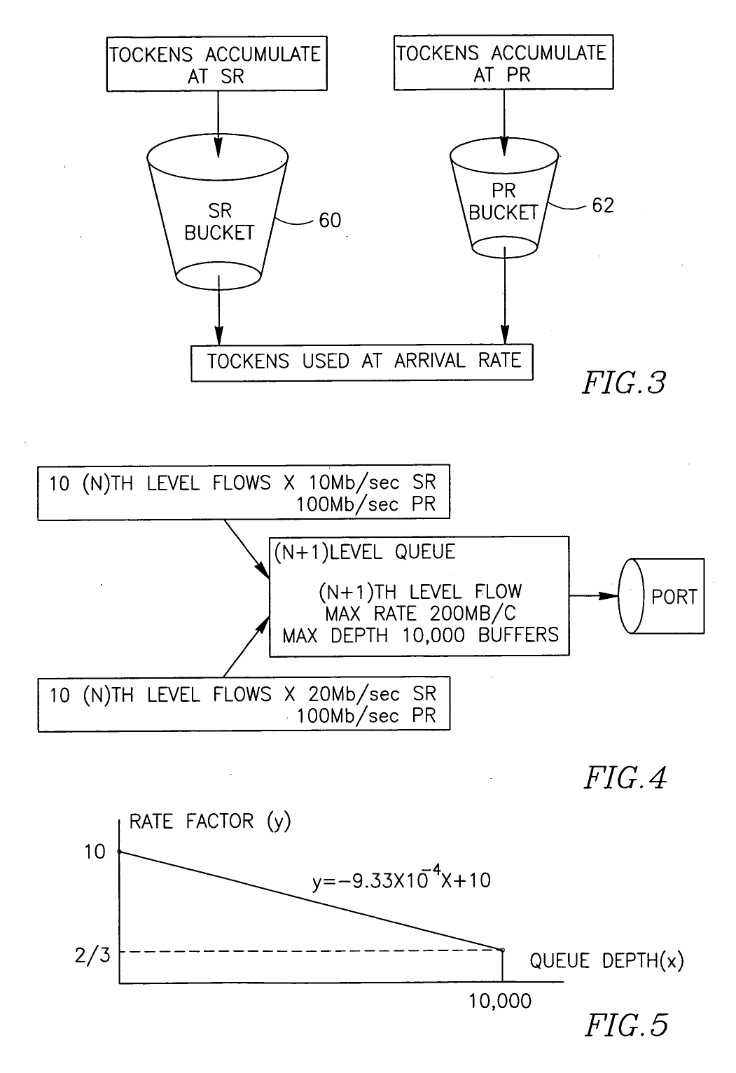

FIG. 3 illustrates a model of an exemplary policer mechanism which can be used for the present invention. The basic policer mechanism is for ensuring per-flow QoS (Quality of Service). The desired aim is to allow for a flow a maximum sustained rate (SR) over time, but also to allow a certain size burst (B) at a higher rate called “peak rate” (PR). The policer is illustrated by a simple block diagram of the Basic QoS Policer Model that comprises two buckets: a bigger bucket 60 is an SR bucket, where tokens accumulate at SR, and a smaller bucket 62 is a PR bucket where tokens accumulate at PR. The tokens accumulated in both of the buckets are used at arrival rate. The policer's algorithm is based on not ever allowing the flow to exceed the peak rate PR, which implies a small PR Bucket, while allowing a burst at the peak rate, but only the sustained rate SR over time. This implies the larger SR Bucket to absorb the burst.

Imagine tokens filling the buckets over time, and the arriving packets using those tokens. Tokens may not accumulate beyond the bucket sizes, in order to avoid bursting beyond the prescribed amount. In addition, the PR bucket is unique in that an arriving packet uses all the existing tokens in the bucket—this prevents the flow from building up tokens and using them to exceed the peak rate.

Suppose the PR Bucket is fixed at 11 KB (or whatever the largest supported packet size is). The SR Bucket size is a function of the rates and burst size. If P is the peak rate, S is the sustained rate, B is the burst size, and U is the bucket size, then U is governed by the following equation:
U=B−B(S/P)

The algorithm is as follows:
Upon packet arrival, determine how many tokens have accumulated in the buckets since the previous arrival, by multiplying the period of time passed since the previous arrival by rate (though the number of tokens is limited to the bucket size).
If the number of tokens in the PR Bucket is less than the packet size, or the number of tokens in the SR Bucket is less than the packet size, then drop the packet.
Otherwise, set the PR Bucket depth to 0 and the SR depth to the accumulated tokens-packet size. Pass the packet and update the bucket depths and timestamp.

FIG. 4 illustrates an example of Per-Plow fair Bandwidth Allocation. Twenty lower granularity flows of two kinds are combined into one higher granularity flow which has a queue with a known maximal depth.

To allocate bandwidth fairly on a per-flow basis using the above-mentioned policer, the peak rate must be a function of the queue depth. Each queue is governed by a linear equation of the form y=mx+b, where “y” is the multiplication factor for the sustained rate SR and “x” is the current queue depth.

It's easiest to demonstrate the algorithm by an example; parameters for the example are shown in FIG. 4.

The desired behavior is as follows:
With only one or two flows active, each should get to burst at 100 Mb/s
With two 10 Mb flows and two 20 Mb flows active, the 10 Mb flows should get to burst at 33 Mb/s each, and the 20 Mb flows should get to burst at 66 Mb/s each (total of 200 Mb/s, with the assigned per-flow bandwidth scaling in proportion to each flow's sustained rate).
With all flows active, the queue is oversubscribed (a total of 300 Mb/s subscribed to a 200 Mb/s queue) and each flow should get ⅔ of its desired rate (6.66 Mb/s and 13.33 Mb/s).

We achieve the desired behavior by programming the “depth factors” for the queue. We must compute the low depth and high depth (i.e. congestion) parameters.

The low depth factor is determined by the worst case multiple required for all flows to achieve their max burst rate. See the equation below (note: L=low depth factor):
L=max(PRn/SRn)

For this example, we have the following computations:
for 10 Mb flows: PR/SR=100/10=10
for 20 Mb flows: PR/SR=100/20=5

So the low depth factor is 10. It is a lower bound or threshold value. To compute the high depth factor, we use the following equation (note: H =High Depth Factor, QR=Queue Rate):
H=QR/(ΣSRn)

In our case, the total queue subscription, or sum of the sustained rates, is 10*10+10*20=300 Mb/s. As mentioned in FIG. 4, the maximal rate of the queue of interest is 200 Mb/s.

Therefore, the high depth factor is ⅔. It is the upper bound value. Using this information, we can plot the line governing the factor “y” vs. queue depth “x” as shown in FIG. 5.

When a flow is policed, the rate used for the burst bucket is governed by the following equation:
Rate=min(R, SR* rate factor “y”)

For example, say the queue depth is 0 when a packet on a 20 Mb flow arrives. Using the plot of FIG. 5, the rate factor “y” is:
y=−9.33*10⁻⁴(0)+10=10;

The rate used for the burst bucket is:
rate=min(100 Mb/s, 20 Mb/s*10), limited to 100 Mb/s.

Here the flow gets 100 Mb/s.

Say the queue is full when a packet arrives on a 10 Mb flow. The rate factor is:
y=−9.33*10⁻⁴(10000)+10=0.67;

The rate used for the burst bucket is:
rate=min(100 Mb/s, 10 Mb/s*0.67)=6.7 Mb/s

At what queue depth does the flow get the desired sustained rate? When “y” is 1:
1=−9.33*10⁻⁴x+10; x=9,646 buffers.

It should be appreciated that not only the above-described models of the policer and the mentioned algorithms for bandwidth allocation are to be considered part of the invention, but also other various models and algorithms can be proposed for implementing the concept and should be considered part of the invention, wherein the general scope of the invention is defined by the claims that follow.

1. A method for policing an N-th granularity level binary flow in a network switching device also handling an (N+1)-th granularity level binary flow supposed to incorporate said N-th granularity level binary flow, wherein said method comprises dynamic bandwidth allocation for said N-th granularity level binary flow, based on dynamically obtaining and processing information of queuing parameters associated with said (N+1)-th granularity level binary flow.

2. The method according to claim 1, wherein the dynamic bandwidth allocation for said N-th granularity level binary flow is performed with dynamically taking into account data about queuing parameters of an (N+2)th granularity level binary flow incorporating said (N+1)-th granularity level binary flow.

3. The method according to claim 1, wherein the N-th granularity level binary flow is a 1^{st} granularity binary flow being the finest granularity flow, and the (N+1)-th granularity level binary flow is a 2^{nd} granularity binary flow incorporating said 1^{st} granularity binary flow.

4. The method according to claim 1, wherein said queuing parameters comprise static and dynamic parameters, and wherein said static parameters of the (N+1)-th granularity level binary flow comprise customer and/or user settings, and the maximal bandwidth allocated to the (N+1)-th granularity level binary flow.

5. The method according to claim 1, wherein said queuing parameters comprise static and dynamic parameters, and wherein said dynamic parameters comprise depth of a queue for queuing the (N+1)-th granularity level binary flow.

6. The method according to claim 5, wherein said dynamic parameters further comprise depth of a queue for queuing an (N+2)-th granularity level binary flow incorporating said (N+1)-th granularity level binary flow.

7. The method according to claim 1, wherein said dynamic bandwidth allocation for said N-th granularity level binary flow is further based on dynamically obtaining and processing information on status of at least one shared resource of said switching device.

8. The method according to claim 1, wherein the dynamical bandwidth allocation is performed by multiplying sustained rate of said at least one N-th granularity level binary flow by a rate factor depending at least on current depth of a queue for queuing the (N+1)-th granularity level binary flow.

9. The method according to claim 1, wherein the dynamical bandwidth allocation is performed on a per-flow basis by governing a peak rate of the N-th granularity level binary flow to be a function of depth of a queue for queuing the (N+1)-th granularity level binary flow.

10. A system for policing one or more N-th granularity level binary flows in a network switching device, wherein the switching device also handles an (N+1)-th granularity level binary flow supposedly incorporating at least one of said N-th granularity level binary flows, the system comprises
an N-th granularity level policer for policing said one or more N-th granularity level binary flows;
an (N+1)-th granularity level queue for queuing said (N+1)-th granularity level binary flow,
means for dynamically obtaining feedback information of queuing parameters associated with said (N+1)-th granularity level binary flow in the (N+1)-th granularity level queue and providing said feedback information to said N-th granularity level policer,
wherein said N-th granularity level policer being adapted to perform dynamic bandwidth allocation for said one or more N-th granularity level binary flows, based on said feedback information.

11. The system according to claim 10, wherein the switch additionally handles an (N+2)-th granularity level binary flow incorporating said (N+1)-th granularity level binary flow, the system further comprises
an (N+2)-th granularity level queue for queuing said (N+2)-th granularity level binary flow, and
an additional means, for dynamically obtaining additional feedback information about queuing parameters of said (N+2)-th granularity level binary flow in the (N+2)-th granularity level queue and providing said additional feedback information to the N-th granularity level policer, wherein said N-th granularity level policer is capable of performing dynamic bandwidth allocation for said one or more N-th granularity level binary flows, based on said additional feedback information.

12. The system according to claim 10, wherein said queuing parameters comprise static and dynamic parameters, and wherein said dynamic parameters comprise at least information on depth of the (N+1)-th granularity level queue.

13. The system according to claim 10, wherein said queuing parameters comprise static and dynamic parameters, and wherein said static parameters comprise customer and/or user settings and the maximal bandwidth allocated to the (N+1)-th granularity level binary flow

14. The system according to claim 10, wherein said N-th granularity level policer is capable of dynamically receiving information from at least one shared resource of the switching device and is operative to perform dynamic bandwidth allocation by further taking into account status of said at least one shared resource.

15. The system according to claim 10, wherein said N-th granularity level policer is capable of performing dynamic bandwidth allocation for said at least one N-th granularity level binary flow by multiplying sustained rate of said at least one N-th granularity level binary flow by a rate factor depending at least on current depth of said (N+1)-th granularity level queue.

16. The system according to claim 10, wherein said N-th granularity level policer is capable of performing dynamic bandwidth allocation on a per-flow basis by governing a peak rate of an N-th granularity level binary flow to be a function of depth of a queue for queuing the (N+1)-th granularity level binary flow.
